(19) United States
(12) Patent Application Publication
(10) Pub. No.: US 2008/0049161 A1
(43) Pub. Date: Feb. 28, 2008

(54) LAMP SUPPORTER AND LIQUID CRYSTAL DISPLAY HAVING THE SAME

(75) Inventors: Choong Sik KIM, Anyang-Si (KR); Yong Woo LEE, Suwon-Si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 11/831,025

(22) Filed: Jul. 31, 2007

(30) Foreign Application Priority Data
Jul. 31, 2006 (KR) 1020060072202

(51) Int. Cl. G02F 1/1333; F21V 19/00; F21V 99/00

(52) U.S. Cl. 349/58; 349/187; 362/382

(57) ABSTRACT

The present invention relates to a lamp supporter having a shock absorbing structure capable of attenuating a shock transferred to a lamp and a liquid crystal display having the same. The lamp supporter includes a base plate having a concavo-convex portion formed in at least a partial region of the base plate, a lamp fixing unit formed on a surface of the base plate and fixing a lamp and an optical member supporting unit formed on the surface of the base plate to support an optical member. The concavo-convex portion includes a predetermined form.

This application claims priority to Korean Patent application No. 2006-0072202 filed on Jul. 31, 2006, and all the benefits accruing therefrom under 35 U.S.C. §119, the contents of which are herein incorporated by reference in its entirety.

### BACKGROUND OF THE INVENTION

1. Field of Invention

The present invention relates to a lamp supporter and a liquid crystal display having the same, and more particularly to a lamp supporter having a shock absorbing structure for a lamp and a liquid crystal display having the same.

2. Description of the Prior Art

A liquid crystal display (“LCD”) is applied in various fields due to its beneficial features such as light weight, thin configuration, low energy consumption, full color, high resolution and the like. The LCD displays desired images on its panel by controlling a light transmission rate according to image signals applied to a plurality of control switches arranged in a matrix form. Such an LCD cannot give a light by itself, such that it requires a light source, such as a backlight. The LCD is classified into an edge-type and a direct-type depending on the position of a light source. In the edge-type, the light source is positioned in a side of an LCD panel, while the light source is positioned below an LCD panel in the direct-type.

Meanwhile, a cold cathode fluorescent lamp is generally used as a light source of the backlight employed in the direct-type LCD. A lamp supporter is also used to prevent a lamp from floating and to support an optical plate (e.g., a diffusion plate) arranged above the lamp.

A conventional lamp supporter will be described with reference to FIG. 1. A conventional lamp supporter 50 includes a base plate 51 formed in a rectangular flat plate shape, lamp fixing units 52 formed on an upper surface of the base plate 51 to fix a lamp, a protrusion 53 for supporting an optical plate (not shown) such as a diffusion plate and hooks 54 for coupling the lamp supporter 50 to a receiving member (not shown). A plurality of lamp supporters 50 configured as mentioned above are coupled to a predetermined region of the receiving member and a lamp is placed on and fixed to the lamp fixing unit 52.

If an external shock is applied to the LCD, this shock is transferred to the lamp through the lamp supporter, thereby occasionally causing breakage of the lamp as shown in FIG. 2. Thus, there is an urgent need of researches for a lamp supporter with a structure capable of absorbing an external shock transferred to a lamp so that the lamp may not be broken in spite of a predetermined external shock.

### BRIEF SUMMARY OF THE INVENTION

In an exemplary embodiment, there is provided a lamp supporter. The lamp supporter includes a base plate having a concavo-convex portion formed in at least a partial region of the base plate, a lamp fixing unit formed on a surface of the base plate and fixing a lamp and an optical member supporting unit formed on the surface of the base plate and supporting an optical member. The concavo-convex portion includes a predetermined form.

In an exemplary embodiment, the lamp supporter may further include a coupling unit formed on another surface of the base plate and coupling the base plate to a receiving member.

In an exemplary embodiment, the concavo-convex portion may have a side formed in one of a sine wave shape, a water wave shape, a square wave shape, a triangular wave shape and a sawtooth wave shape.

In an exemplary embodiment, the base plate may be formed in a square shape or a rectangular shape.

In an exemplary embodiment, the concavo-convex portion extends in a first axial direction of the base plate.

In an exemplary embodiment, the concavo-convex portion extends in a second axial direction that is inclined at a predetermined angle from the first axial direction of the base plate.

In an exemplary embodiment, the first axis and the second axis perpendicularly cross each other.

In an exemplary embodiment, the base plate may include a flat portion formed in a central region thereof with a flat surface, and the concavo-convex portions may be symmetrically arranged at opposing sides of the base plate with respect to the flat portion.

In an exemplary embodiment, the optical member supporting unit is arranged on the flat portion of the base plate.

In an exemplary embodiment, the lamp fixing unit is arranged on the concavo-convex portion.

In an exemplary embodiment, the lamp supporter may include plastic material.

In an exemplary embodiment, the lamp fixing unit may include a body formed on a surface of the base plate, a lamp seating portion formed on a distal end of the body and a projecting portion formed on an inside of the lamp seating portion.

In an exemplary embodiment, the projecting portion includes a dot-shaped or linear protrusion.

In an exemplary embodiment, the base plate, the lamp fixing unit, the optical plate supporting unit and the coupling unit of the lamp supporter may be integrally formed.

In an exemplary embodiment, there is provided a liquid crystal display. The liquid crystal display includes a liquid crystal display panel displaying images, a lamp unit providing a light to the liquid crystal display panel and a receiving member having an accommodating space therein. The lamp unit includes a lamp and a lamp supporter. The lamp supporter includes a base plate supporting the lamp, the base plate having a concavo-convex portion formed in at least partial region thereof with a predetermined form.

In an exemplary embodiment, the lamp supporter may further include a coupling unit formed on a surface of the base plate and coupling the base plate to the receiving member. A coupling hole is formed in the receiving member to insert the coupling unit therein.

In an exemplary embodiment, the lamp supporter may further include a lamp fixing unit formed on the other side of the base plate to fix a lamp.

In an exemplary embodiment, the liquid crystal display may further include at least one optical member. The lamp supporter further includes an optical member supporting unit formed on the other surface of the base plate to support the optical member.

### BRIEF DESCRIPTION OF THE DRAWINGS

The above and other objects, features and advantages of the present invention will become apparent from the following description of preferred embodiments given in conjunction with the accompanying drawings, in which:

FIG. 1 is a front view showing a conventional lamp supporter of the prior art;

FIG. 2 is a photograph showing that a lamp supported by a conventional lamp supporter of the prior art is broken down due to a shock;

FIGS. 3A and 3B are front and perspective views, respectively, showing an exemplary embodiment of a lamp supporter according to the present invention;

FIGS. 4A and 4B are enlarged front and perspective views, respectively, showing an exemplary embodiment of a coupling unit of the lamp supporter of FIGS. 1 and 2;

FIG. 4C is a perspective view showing another exemplary embodiments of the coupling unit;

FIGS. 5A and 5B are perspective views showing exemplary embodiments of states before and after the lamp supporter is coupled to a lower receiving member, respectively;

FIGS. 6A and 6B are perspective and front views, respectively, showing another exemplary embodiment of a lamp fixing unit according to the present invention;

FIGS. 6C and 6D are perspective and front views, respectively, showing another exemplary embodiment of the lamp fixing unit according to the present invention;

FIGS. 7A and 7B are plane and perspective views, respectively, showing another exemplary embodiment of a lamp supporter according to the present invention;

FIGS. 8A and 8B are front and perspective views, respectively, showing another exemplary embodiment of a lamp supporter according to the present invention;

FIGS. 9A and 9B are front and perspective views, respectively, showing a lamp supporter according to the present invention;

FIGS. 9C and 9D are perspective and plane views, respectively, showing another exemplary embodiment of a lamp supporter according to the present invention;

FIG. 10A is a schematic perspective view showing an exemplary embodiment of the lower receiving member to which the lamp supporter according to the present invention may be coupled;

FIG. 10B is an exploded perspective view showing an exemplary embodiment of a liquid crystal display according to the present invention; and

FIGS. 11A and 11B are graphs showing simulation results of stresses applied to lamps supported by a conventional lamp supporter and a lamp supporter according to the present invention.

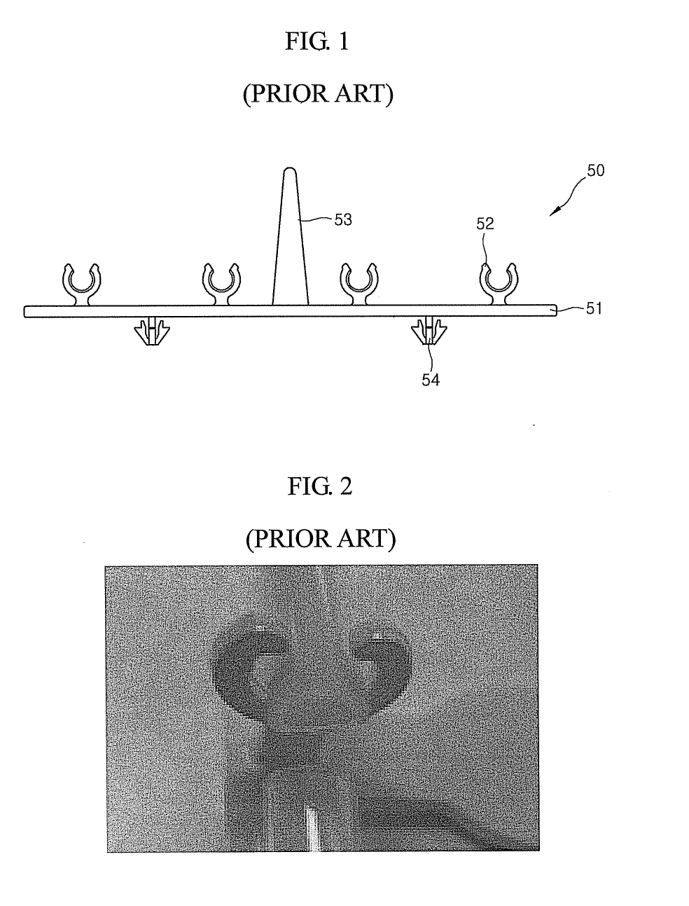

### DETAILED DESCRIPTION OF THE INVENTION PREFERRED EMBODIMENT

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, the element or layer can be directly on, connected or coupled to another element or layer or intervening elements or layers. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “below”, “lower”, “above”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” or “lower” relative to other elements or features would then be oriented “above” the other elements or features. Thus, the exemplary term “below” or “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, preferred embodiments of the present invention will be described in detail with reference to the accompanying drawings.

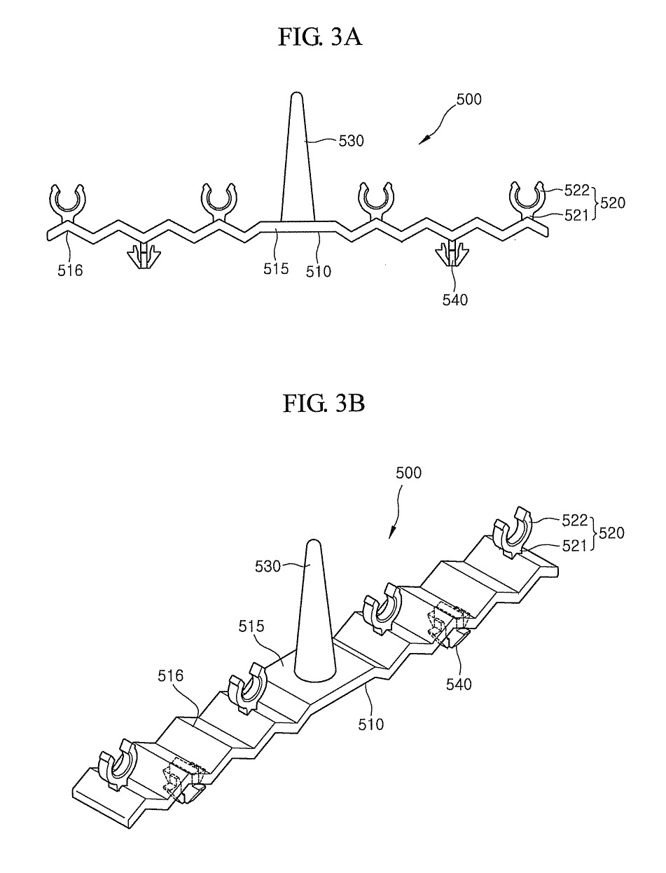

FIGS. 3A and 3B are front and perspective views, respectively, showing an exemplary embodiment of a lamp supporter according to the present invention.

Referring to FIGS. 3A and 3B, a lamp supporter 500 includes a base plate 510, lamp fixing units 520, a supporting unit 530 such as for an optical member or plate, and coupling units 540.

The base plate 510 is formed in a generally rectangular shape, e.g., a quadrangular shape with one side (e.g., longitudinal side) longer than another side (e.g., transverse side). The base plate 510 has a flat portion 515 formed in a substantially central region with a substantially flat surface The base plate 510 includes concavo-convex portions 516 formed at opposite sides with respect to the flat portion 515. The base plate 510 includes the flat portion 515 and the concavo-convex portions 516, and the flat portion 515 is arranged between the concavo-convex portions 516. The concavo-convex portions 516 may be formed symmetrically about the flat portion 515 as illustrated in FIGS. 3A and 3B. In an alternative embodiment, the concavo-convex portions 516 may be formed asymmetrically about the flat portion 515.

The concavo-convex portion 516 is formed to have a side profile which may be considered as an extending corrugation shape of a triangular wave. The concavo-convex portion 516 extends in one axial direction of the base plate 510, such as in an x-axis direction. In the illustrated embodiment, the concavo-convex portion 516 is formed in a triangular wave form of which the right and left sides are symmetric, but the present embodiment is not limited thereto and may also be formed in a sawtooth wave form of which the right and left sides are asymmetric.

In addition, although in the illustrated embodiment, the base plate 510 is formed in a generally rectangular shape, the present embodiment is not limited thereto and may also be formed in various shapes such as a regular square shape or an oval shape.

Further, although the central region of the base plate 510 is formed in a substantially flat plate shape and not in the shape of the concavo-convex portion 516 in the illustrated embodiment, the present embodiment is not limited thereto. In an exemplary embodiment, the entire region of the base plate 510 may be formed in the shape of the concavo-convex portion 516. In an alternative exemplary embodiment, a plurality of the flat portions 515 may be arranged as the base plate 510. In one exemplary embodiment, the flat portions may be interposed in the middle of the concavo-convex portion 516 as well as in the central region of the base plate 510.

In exemplary embodiments, if the base plate is formed to have the concavo-convex portion at least partially as in the illustrated embodiment, the base plate is made with a greater (straightened) length while having the same overall size (e.g., length) compared with a conventional base plate. Advantageously, if a shock is applied from an outside, the base plate of the illustrated embodiment has a shock transferring path longer than that of a conventional base plate, such that it absorbs the shock more efficiently. In addition, since the lamp supporter includes the concavo-convex portion, the lamp may not be fixed to the lamp supporter overly static or rigidly, and an external shock is also absorbed to improve a shock resistance against to an external shock.

Referring again to FIGS. 3A and 3B, the lamp fixing unit 520 is formed on a first surface, e.g., an upper surface, of the base plate 510. The lamp fixing unit 520 includes a body 521 formed on the base plate 510 and a lamp seating portion 522 formed on an distal end of the body 521 to provide a predetermined place on which a lamp is to be placed. As in the illustrated embodiment, the lamp seating portion 522 is formed in a ring shape of which a predetermined portion, e.g., an upper portion, is opened. A lamp (not shown) is inserted into through the open portion of the lamp seating portion 522 and fixed to the lamp seating portion 522. In this illustrated embodiment, the lamp seating portion 522 is formed in a ring shape with a portion opened, but the lamp seating portion 522 is not limited thereto and may be formed in various shapes.

In addition, although four of the lamp fixing units 520 are arranged at regular intervals across the concavo-convex portions 516 respectively located to both the opposite sides of the flat portion 515 of the base plate 510 in this embodiment, the number and position of the lamp fixing units is not limited thereto and may be changed in various ways.

The optical plate supporting unit 530 is formed on the surface, e.g., the upper surface, of the base plate 510, and formed in a substantially protrusion shape so as to support an optical plate or sheet. This optical plate supporting unit 530, which may be used for supporting an optical plate, such as a diffusion plate (not shown) arranged over the lamp, or supporting an optical sheet, such as a prism sheet or a diffusion sheet, is formed on the flat portion 515 at the center of the base plate 510. In addition, in order to dispose the optical plate over the lamp, the optical plate supporting unit 530 is formed higher than the lamp fixing units 520 and may have a truncated conical shape, but the shape of the optical plate supporting unit is not limited thereto and may have various shapes.

The coupling units 540 are formed on a second surface, e.g., a lower surface, of the base plate 510 to couple the base plate 510 to a receiving member (not shown). The coupling units 540 are respectively arranged on the concavo-convex portions 516 arranged to both the opposite sides of the flat portion 515, but the number and position of the coupling units are not limited to the illustrated embodiment of FIGS. 3A and 3B and may be changed in various ways. Such a coupling unit 540 will be explained later in more detail.

The base plate 510, the lamp fixing units 520, the optical plate supporting unit 530 and the coupling units 540 of the lamp supporter 500 as in the illustrated embodiment, may be formed integrally with each other and made of a material with excellent shock resistance, for example plastic material. As used herein, the term “integrally” is used to indicate formed to be a single unit or piece rather than combining separate elements.

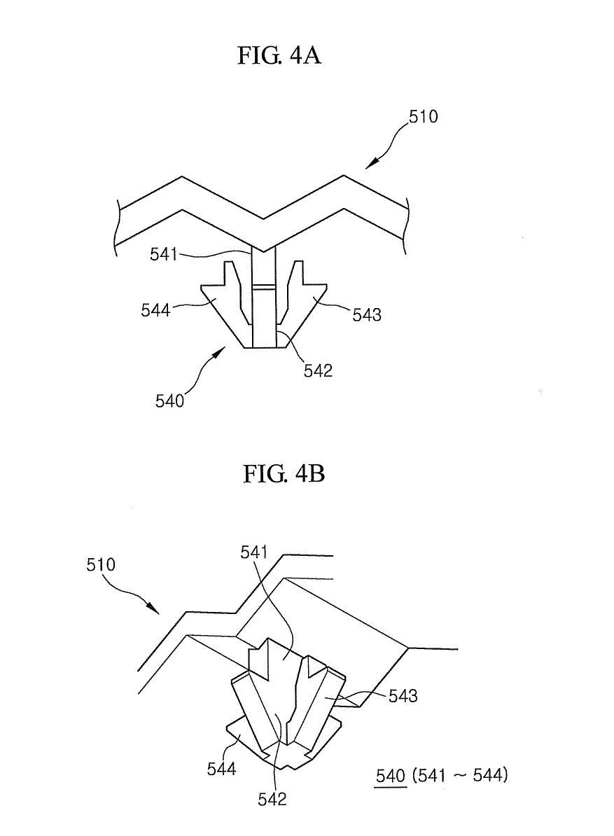

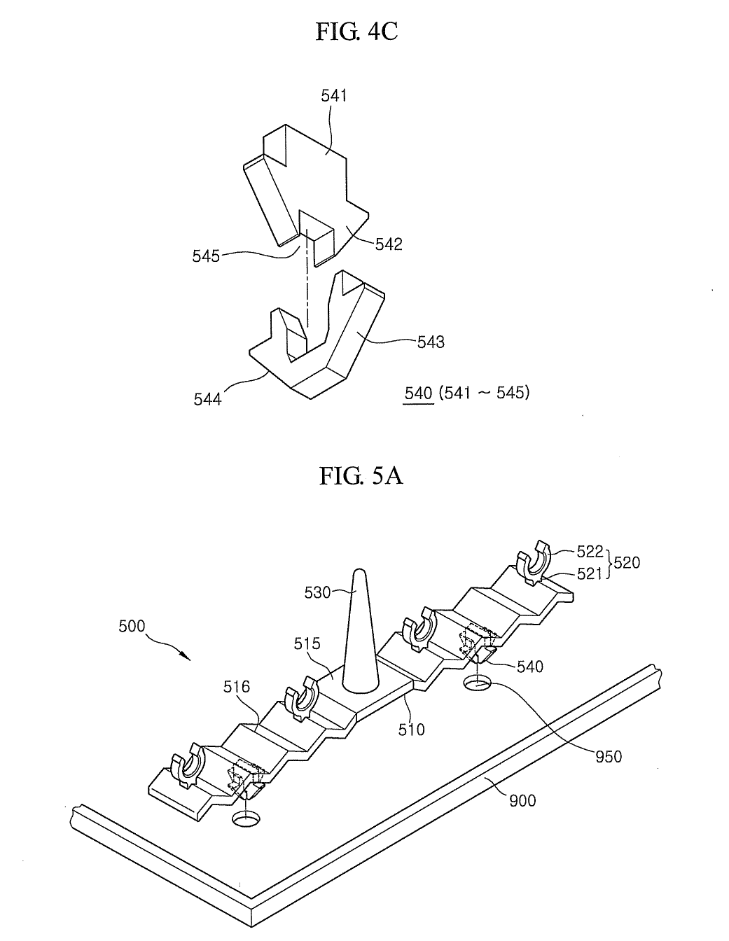

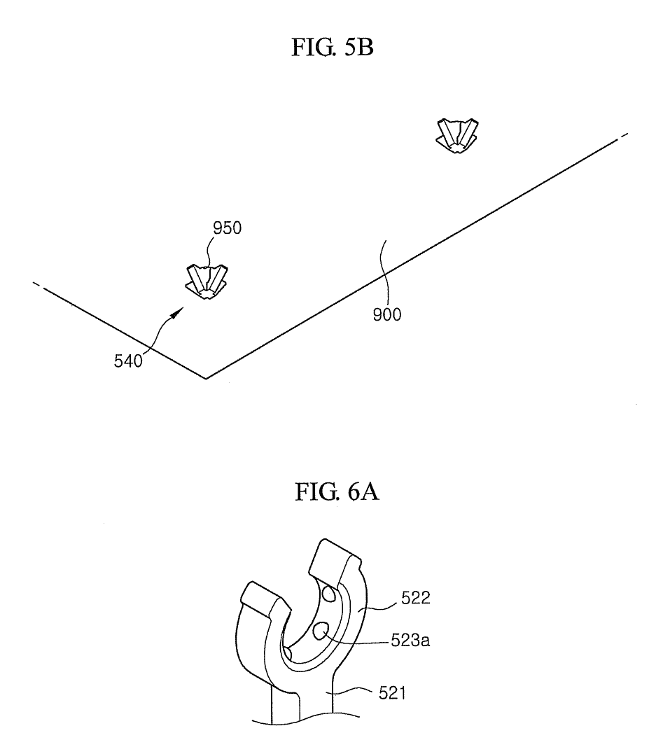

FIGS. 4A and 4B are enlarged front and perspective views, respectively, showing an exemplary embodiment of the coupling unit of the lamp supporter, FIG. 4C is a perspective view showing another exemplary embodiment of the coupling unit, and FIGS. 5A and 5B are perspective views showing exemplary embodiments of states before and after the lamp supporter is coupled to a lower receiving member, respectively.

Referring to FIGS. 4A to 5B, a plurality of coupling units 540 are formed on the lower surface of the base plate 510. Each coupling unit 540 has a body extending downward and a head with elasticity at a distal end of the body. In the illustrated embodiments, each coupling unit 540 includes a body 541, a first head 542, a second head 543 and a third head 544.

The body 541 of the coupling unit 540 is formed to vertically extend from the lower surface of the base plate 510. The first head 542 is formed at the distal end of the body 541. The second head 543 is arranged to cross the first head 542 and the third head 544 is arranged to cross the first head 542 and to be opposite to the second head 543 relative to the first head 542. The second head 543 and the third head 544 are respectively formed to protrude from opposing surfaces of the first head 542 and to be spaced apart by a predetermined gap from the opposing surfaces of the first head 542, thereby giving the coupling unit 540 a predetermined elasticity. In addition, each head is formed to taper as it goes in a direction from the base plate 510 toward the distal end of the coupling unit 540. As in the illustrated embodiment, the body 541, the first head 542, the second head 543 and the third head 544 may be formed integrally, but the present invention is not limited thereto.

Referring to FIGS. 5A and 5B, coupling holes 950 are formed in a lower receiving member 900. Each of the coupling holes 590 has a predetermined shape corresponding to the coupling unit 540. The coupling holes 590 may be considered as corresponding substantially in shape, size or positional placement relative to the coupling units 540. As in the illustrated embodiment, the coupling hole 590 may have a substantially circular shape. The coupling units 540 are respectively inserted into the coupling holes 950, so that the lamp supporter 500 is fixed to the lower receiving member 900.

FIG. 4C shows another exemplary embodiment of the coupling unit 540. Although the second head 543 and third head 544 are formed integrally with the body 541 in the embodiment of FIGS. 4A and 4B, the second and third heads 543 and 544 are formed integrally with each other, but separately from the body 541 in the illustrated embodiment of FIG. 4C. A groove 545 is formed at a distal end of the first head 542, whereby the second and third heads 543 and 544 integrally formed are coupled into the groove 545. The coupling unit of the lamp supporter according to the present invention may be configured in various ways in addition to the above.

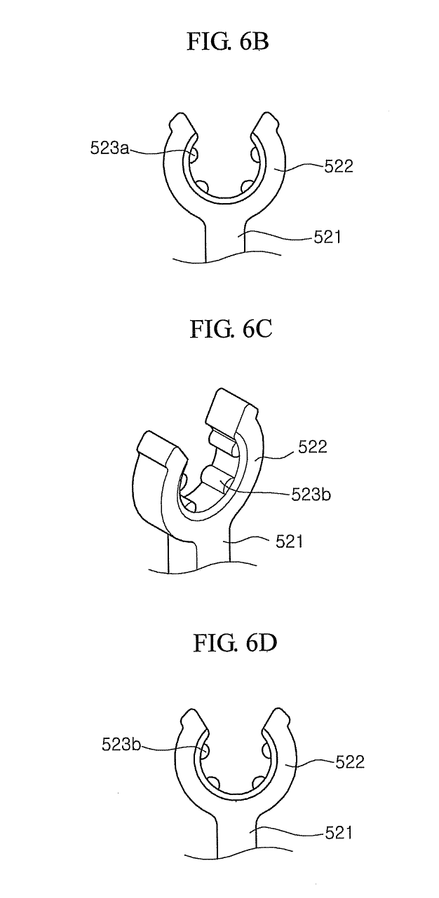

FIGS. 6A and 6B are perspective and front views showing another exemplary embodiment of the lamp fixing unit according to the present invention, and FIGS. 6C and 6D are perspective and front views, respectively, showing another exemplary embodiment of the lamp fixing unit according to the present invention.

Referring to FIGS. 6A to 6D, the lamp fixing unit 520 includes the body 521, the lamp seating portion 522 and a projecting portion 523.

The body 521 is formed on the surface, such as the upper surface, of the base plate 510 and the lamp seating portion 522 providing a predetermined place on which a lamp is to be placed is arranged at the distal end of the body 521. The lamp seating portion 522 is formed in substantially a ring shape of which a predetermined portion, preferably the upper portion, is opened. The projecting portion 523 are arranged at intervals on an inner side surface of the lamp seating portion 522 and a lamp (not shown) is fixed in contact with such a projecting portion 523.

The projecting portion 523 may include a plurality of dot-shaped protrusions 523a as shown in FIGS. 6A and 6B, and each dot-shaped protrusion has a semispherical shape. However, the number and shape of the dot-shaped protrusions 523a may be changed in various ways. In addition, the projecting portion 523 may include a plurality of linear (or semicylindrical) protrusions 523b as shown in FIGS. 6C and 6D. The linear protrusions 523b extend in a direction substantially parallel with a longitudinal direction of the lamp and are arranged to be spaced apart from each other in a circumferential direction of the lamp at substantially regular intervals.

Advantageously, when the lamp is fixed by means of the projecting portion, a contact area between the lamp seating portion and the lamp is reduced, thereby absorbing a shock applied to the lamp.

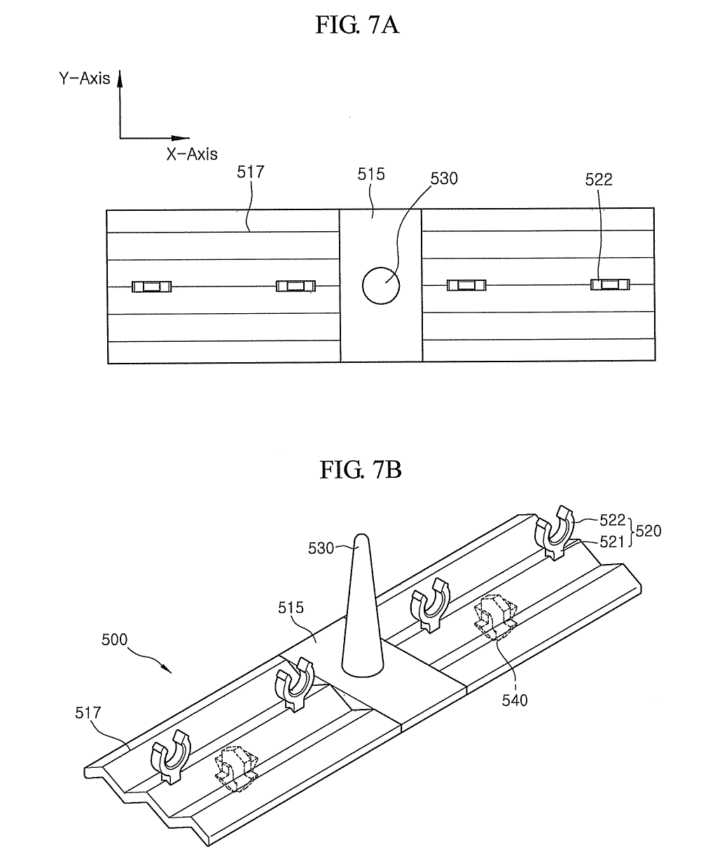

FIGS. 7A and 7B are plane and perspective views, respectively, showing another exemplary embodiment of a lamp supporter according to the present invention. The lamp supporter of FIGS. 7A and 7B is substantially similar to the lamp supporter of FIGS. 3A and 3B, except for an extending direction of the concavo-convex portion, so that the following description will be focused on such a difference.

Referring to FIGS. 7A and 7B, a lamp supporter 500 includes a base plate 510, lamp fixing units 520, an optical plate supporting unit 530 and coupling units 540.

The base plate 510 has a flat portion 515 formed in a predetermined central region with a flat surface and concavo-convex portions 517 are symmetrically formed at opposing sides of the base plate 510 with respect to the flat portion 515. The base plate 510 includes the flat portion 515 and the concavo-convex portions 517 and the flat portion 515 is arranged between the concavo-convex portions 517.

The concavo-convex portion 517 is formed is formed to have a side profile which may be considered as an extending corrugation shape of a triangular wave. The concavo-convex portion 517 extend in another axial direction (e.g., transverse direction) of the base plate 510, such as in a y-axis direction. In the illustrated embodiment, the concavo-convex portions 517 are formed in a triangular wave form of which the right and left sides are symmetric, but the present embodiment is not limited thereto and may also be formed in a sawtooth wave form of which the right and left sides are asymmetric and changed in various ways. Although the concavo-convex portions 517 have been illustrated extending in the y-axis direction substantially perpendicular to the x-axis direction, the concavo-convex portions are not limited thereto and may also extend in a direction inclined at a predetermined angle from the x-axis direction, e.g., in an oblique direction.

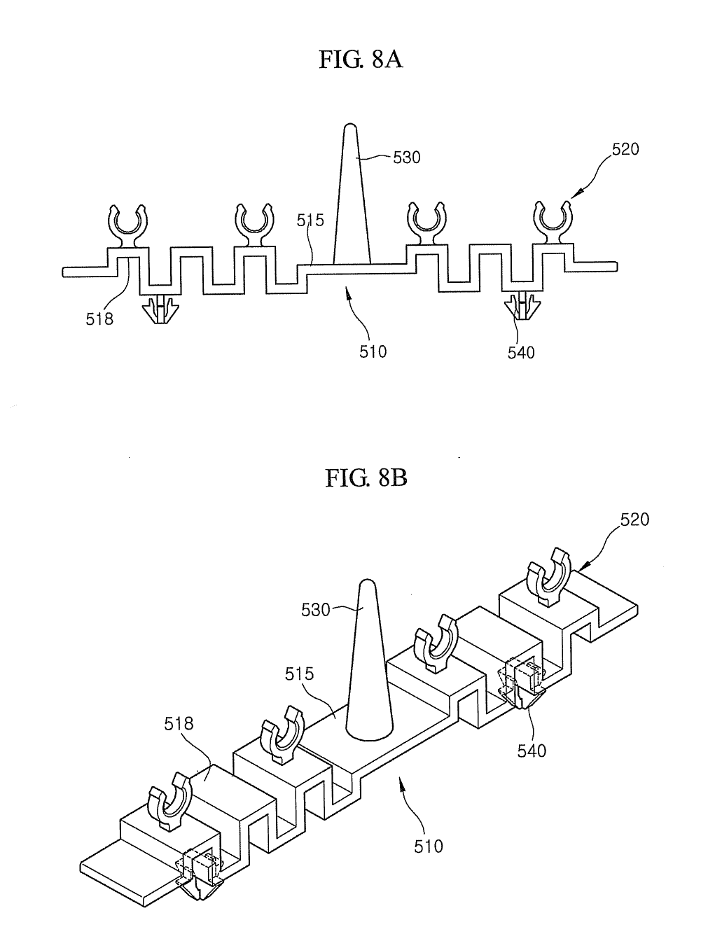

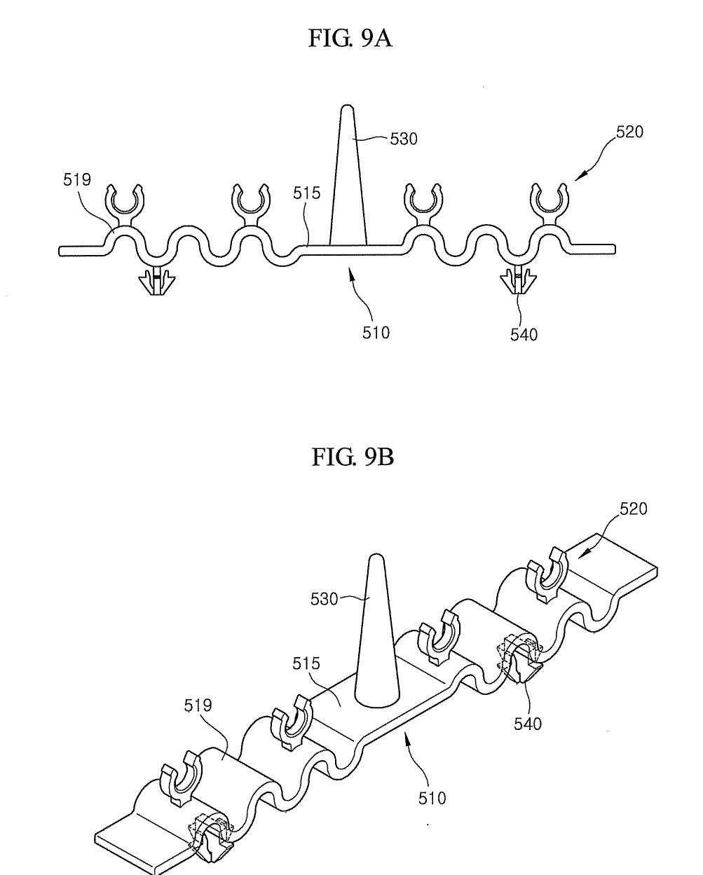

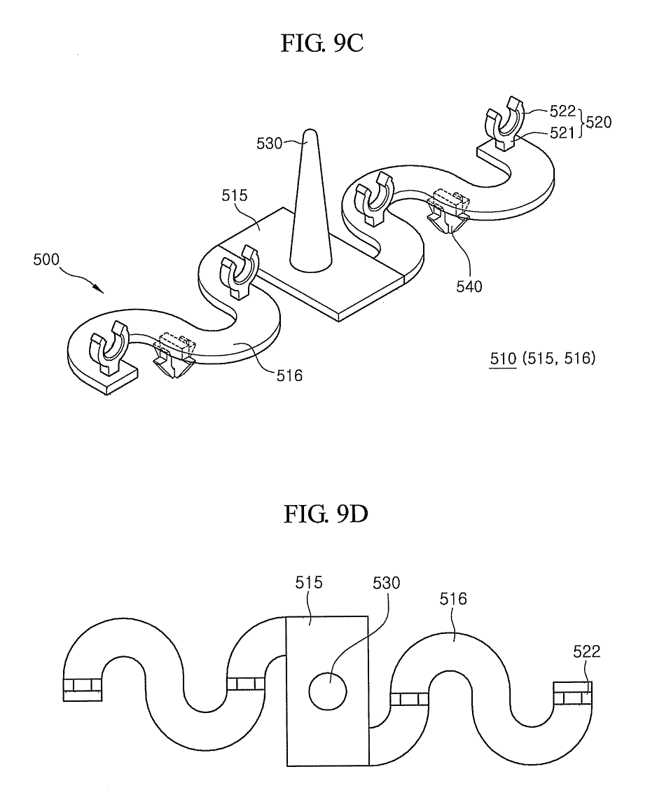

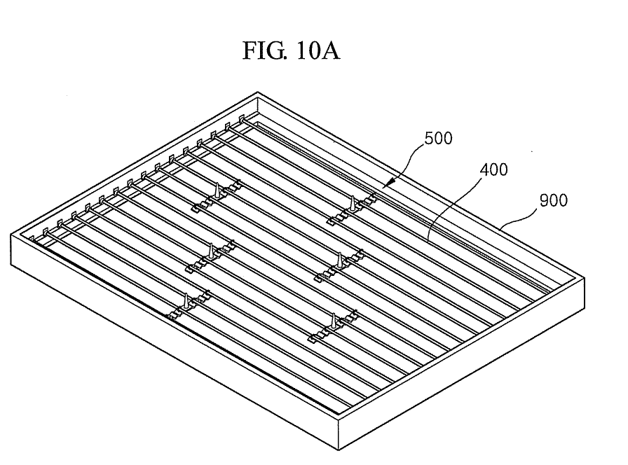

FIGS. 8A and 8B are front and perspective views, respectively, showing another exemplary embodiment of a lamp supporter according to the present invention, and FIGS. 9A and 9B are front and perspective views, respectively, showing another exemplary embodiment of a lamp supporter according to the present invention. The lamp supporters of FIGS. 8A to 9D are substantially identical to the lamp supporter of FIGS. 3A and 3B, except for a shape of the concavo-convex portion, so that the following descriptions will be focused on such a difference.

A lamp supporter 500 of FIGS. 8A and 8B includes a base plate 510, lamp fixing units 520, an optical plate supporting unit 530 and coupling units 540.

The base plate 510 is formed in a generally rectangular shape, e.g., a quadrangular shape with one side longer than another side. The base plate 510 has a flat portion 515 formed substantially in a central region with a flat surface. The base plate 510 includes concavo-convex portions 518 symmetrically formed at both opposite sides with respect to the flat portion 515. The base plate 510 includes the flat portion 515 and the concavo-convex portions 518, and the flat portion 515 is arranged between the concavo-convex portions 518. At this time, the concavo-convex portion 518 is formed to have a side profile of an extending corrugation shape of a square wave The concavo-convex portion 518 extends in one axial direction of the base plate 510, such as in an x-axis direction as illustrated in FIGS. 8A and 8B or may extend in a y-axis direction.

Referring to FIGS. 9A and 9B, a lamp supporter 500 is substantially similar to that of FIGS. 8A and 8B, except that the base plate 510 has concavo-convex portions 519 each of which is formed to have a side profile of an extending corrugation shape of a sine wave or water wave. The concavo-convex portion 519 extends in one axial direction of the base plate 510, such as in an x-axis direction as illustrated in FIGS. 9aA and 9B or may extend in a y-axis direction.

Referring to FIGS. 9C and 9D, a lamp supporter 500 is substantially similar to that of FIGS. 9A and 9B, except that the base plate 510 has concavo-convex portions 516 each of which is formed to have a plane profile of an extending corrugation shape of a sine wave or water wave.

In the illustrated embodiment, the concavo-convex portions 516 are formed in a sine wave or a water wave, but the present embodiment is not limited thereto and may also be formed in a square wave shape, a triangular wave shape or a sawtooth wave shape and changed in various ways.

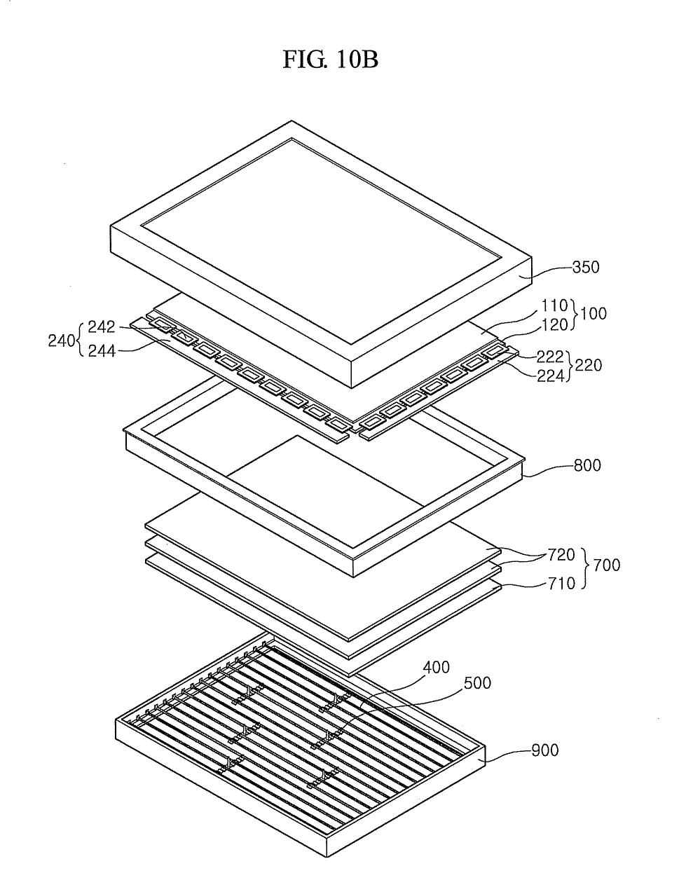

FIG. 10A is a schematic perspective view showing an exemplary embodiment of the lower receiving member to which the lamp supporter according to the present invention is coupled, and FIG. 10B is an exploded perspective view showing an exemplary embodiment of a liquid crystal display according to the present invention.

Referring to FIGS. 10A and 10B, a liquid crystal display includes an upper receiving member 350, a liquid crystal display panel 100, driving circuits 220 and 240, a mold frame 800, an optical member 700, a plurality of lamps 400 and a lower receiving member 900. A lamp unit includes the lamps 400 and the lamp supporters 500.

The driving circuits 220 and 240 are connected to the liquid crystal display panel 100 and include a gate-side printed circuit board 224 having a control IC (Integrated Circuit) mounted thereon and applying a predetermined gate signal to a gate line of a TFT substrate 120, a data-side printed circuit board 244 having a control IC mounted thereon and applying a predetermined data signal to a data line of the TFT substrate 120, a gate-side flexible printed circuit board 222 for connecting the TFT substrate 120 and the gate-side printed circuit board 224, and a data-side flexible printed circuit board 242 for connecting the TFT substrate 120 and the data-side printed circuit board 244. Driving ICs (not shown) may be mounted on the flexible printed circuit boards 222 and 242 in order to transmit digital power and RGB (Red, Green and Blue) signals generated from the printed circuit boards 224 and 244, to the liquid crystal display panel 100.

The optical member 700 and the liquid crystal display panel 100 are accommodated on a bottom surface in an accommodating space defined in the mold frame 800. A plurality of lamp supporters 500 are coupled and fixed in an accommodating space of the lower receiving member 900. In addition, the lamps 400 are placed and fixed to the lamp supporters 500. Since the base plate 510 of the lamp supporter 500 has the concavo-convex portions, a shock transferring path of the base plate 510 overall becomes longer than that of a conventional lamp supporter, such that the base plate 510 absorbs more a shock and transfers only the attenuated shock to the lamp. Advantageously, the shock transferred to the lamp is further lowered, whereby it is possible to decrease breakage of the lamp caused from external shocks.

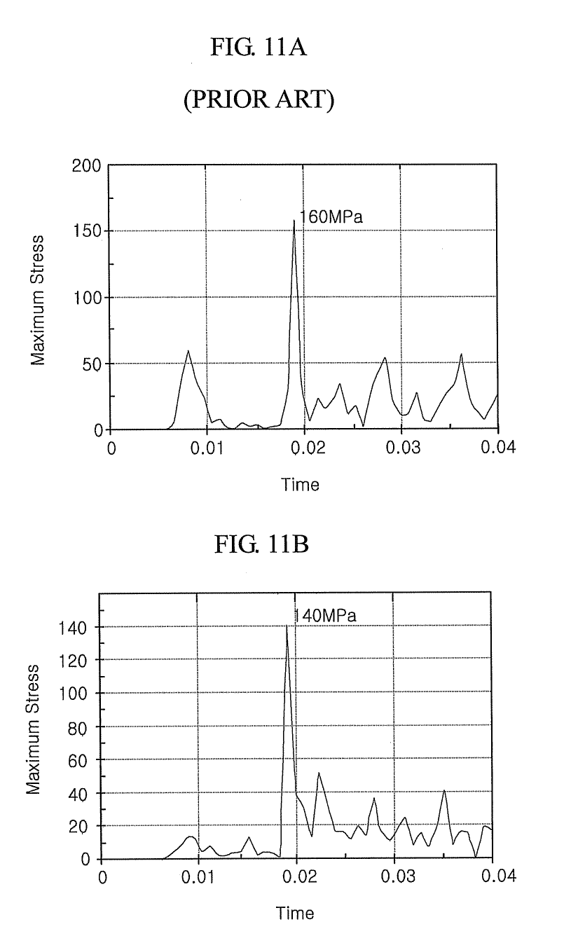

FIGS. 11A and 11B are graphs showing simulation results of stresses applied to lamps supported by a conventional lamp supporter and a lamp supporter according to the present invention, respectively.

Referring to FIG. 11A, a maximum stress applied to the lamp supported by the conventional lamp supporter is approximately 162 Mpa.

Referring to FIG. 11B, a maximum stress applied to the lamp supported by the lamp supporter according to the present invention, which includes the base plate having the concavo-convex portion with a predetermined shape, is approximately 140 Mpa, which shows about 14% reduction in the maximum stress as compared with the prior art.

As in the illustrated exemplary embodiments, the base plate of the lamp supporter is configured to have a concavo-convex portion with a variety of shapes and a transferring path of the shock applied from the outside gets longer, such that the shock transferred to a lamp through the lamp supporter may be attenuated.

Advantageously, a maximum stress applied to the lamp is considerably reduced as compared with the prior art, so that the breakage deterioration of lamp caused by an external shock may be effectively solved.

The lamp supporter according to the present invention as described above and the liquid crystal display having the same are merely illustrative embodiments. The present invention is not limited thereto, but it will be readily understood by those skilled in the art that various modifications and changes can be made thereto within the technical spirit and scope of the present invention as defined by the appended claims.

What is claimed is:

1. A lamp supporter comprising:
a base plate including a concavo-convex portion formed in a partial region of the base plate, the concavo-convex portion including a predetermined form;
a lamp fixing unit formed on a first surface of the base plate to fix a lamp; and
an optical member supporting unit formed on the first surface to support an optical member.

2. The lamp supporter as claimed in claim 1, further comprising a coupling unit formed on a second surface of the base plate to couple the base plate to a receiving member, the second surface being opposite to the first surface.

3. The lamp supporter as claimed in claim 1, wherein the concavo-convex portion includes a side formed one of a sine wave shape, a water wave shape, a square wave shape, a triangular wave shape or a sawtooth wave shape.

4. The lamp supporter as claimed in claim 1, wherein the base plate is formed in a square shape or a rectangular shape.

5. The lamp supporter as claimed in claim 4, wherein the concavo-convex portion extends in a first axial direction of the base plate.

6. The lamp supporter as claimed in claim 5, wherein the concavo-convex portion extends in a second axial direction that is inclined at a predetermined angle from the first axial direction of the base plate.

7. The lamp supporter as claimed in claim 5, wherein the first axial direction is parallel to a longitudinal direction of the base plate.

8. The lamp supporter as claimed in claim 5, wherein the first axial direction is parallel to a transverse direction of the base plate.

9. The lamp supporter as claimed in claim 6, wherein the first axial direction and the second axial direction perpendicularly cross each other.

10. The lamp supporter as claimed in claim 1, wherein the base plate includes a flat portion formed in a central region of the base plate and including a flat surface, and the concavo-convex portions are symmetrically arranged at opposing sides of the base plate with respect to the flat portion.

11. The lamp supporter as claimed in claim 10, wherein the optical member supporting unit is arranged on the flat portion of the base plate.

12. The lamp supporter as claimed in claim 11, wherein the lamp fixing unit is arranged on the concavo-convex portion.

13. The lamp supporter as claimed in claim 1, wherein the lamp supporter includes plastic material.

14. The lamp supporter as claimed in claim 1, wherein the lamp fixing unit is arranged on the concavo-convex portion and includes a body formed on the first surface of the base plate, a lamp seating portion formed on a distal end of the body and a projecting portion formed on an inside of the lamp seating portion.

15. The lamp supporter as claimed in claim 14, wherein the projecting portion includes a dot-shaped or linear protrusion.

16. The lamp supporter as claimed in claim 2, wherein the base plate, the lamp fixing unit, the optical member supporting unit and the coupling unit are integrally formed.

17. A liquid crystal display comprising:
a liquid crystal display panel displaying images;
a lamp unit providing a light to the liquid crystal display panel; and
a receiving member including an accommodating space therein,
wherein the lamp unit includes a lamp and a lamp supporter including a base plate supporting the lamp, the base plate including a concavo-convex portion formed in at least partial region of the base plate and the convaco-convex portion including a predetermined form.

18. The liquid crystal display as claimed in claim 17, wherein the lamp supporter further includes a coupling unit formed on a lower surface of the base plate and coupling the base plate to the receiving member, and a coupling hole formed in the receiving member to insert the coupling unit therein.

19. The liquid crystal display as claimed in claim 17, wherein the lamp supporter further includes a lamp fixing unit formed on an upper side of the base plate and fixing the lamp.

20. The liquid crystal display as claimed in claim 19, wherein the lamp fixing unit is arranged on the concavo-convex portion and includes a body formed on the first surface of the base plate, a lamp seating portion formed on a distal end of the body and a projecting portion formed on an inside of the lamp seating portion.

21. The liquid crystal display as claimed in claim 17, further comprising an optical member, wherein the lamp supporter further includes an optical member supporting unit formed on an upper surface of the base plate and supporting the optical member.

22. A method of forming a lamp supporter for a liquid crystal display, the method comprising:
forming a concavo-convex portion and a flat portion in a base plate;
forming a lamp fixing unit on an upper surface of the concavo-convex portion;
forming an optical member supporting unit on an upper surface of the flat portion; and
forming a coupling unit on a lower surface of the base plate;
wherein the concavo-convex portion is formed on opposing sides of the base plate relative to the flat portion.

23. The method as claimed in claim 22, wherein the forming a lamp fixing unit comprises:
forming a body protruding from an upper surface of the base plate;
forming a lamp seating portion on a distal end of the body; and
forming a projecting portion on an inside surface of the lamp seating portion.
